(19) United States
(12) Patent Application Publication
(10) Pub. No.: US 2012/0034036 A1
(43) Pub. Date: Feb. 9, 2012

(54) FRICTION STABILISER

(76) Inventor: Gary Robert Davison, Williamstown (AU)

(21) Appl. No.: 13/263,637

(22) PCT Filed: Apr. 15, 2010
(86) PCT No.: PCT/AU2010/000410

§ 371 Date: Oct. 7, 2011

(30) Foreign Application Priority Data
Apr. 16, 2009 (AU) 2009901614

(51) Int. Cl. E21D 20/02; C09K 17/00

(52) U.S. Cl. 405/259.5; 405/266

(57) ABSTRACT

A method of installing a stabiliser into a hole provided in an area to be stabilised, the method comprising the step of providing a filler material adapted to be associated with a stabiliser, the filler material, in association with the stabiliser, enabling frictional engagement of the stabiliser with a surrounding environment to be less than the tensile strength of the stabiliser.

### FIELD OF INVENTION

The present invention relates generally to devices used to anchor, secure or stabilise earthen formations, such as the roof or side walls of an underground mine or tunnel. Devices of this type are usually referred to by many names including rock stabiliser, rock-bolt, roof-bolt, friction stabiliser or split-set bolt. Hereinafter, we will refer to these devices generally as friction stabilisers.

The present invention also relates particularly to a stabiliser structure that reduces known difficulties associated with such devices. Further, the present invention provides a method of installation of stabilisers that reduces known difficulties associated with stabilisers and installation of such devices.

It will be convenient to hereinafter describe the invention in relation to friction stabilisers, however it should be appreciated that the present invention is not limited to that use only.

### BACKGROUND ART

Throughout this specification the use of the word “inventor” in singular form may be taken as reference to one (singular) inventor or more than one (plural) inventor of the present invention. The discussion throughout this specification comes about due to the realisation of the inventor(s) and/or the identification of certain prior art problems by the inventors.

Friction stabilisers are used as reinforcing pins that are located inside a hole in rock, concrete and the like. The friction stabilisers inhibit movement within the rock. For instance, if a friction stabiliser is pinned across two regions of a rock, the bolt will inhibit the two regions from moving with respect to one another. Typically, such friction stabilisers are used in mines where the bolts are used to prevent parts of the rock face from moving and falling away.

Stabilisers generally comprise an elongate tube of a substantially circular cross-section with a channel or groove extending longitudinally along the entire length of the tube. Stabilisers are usually installed into a hole bored Into an earthen formation requiring support with the hole being of a lesser diameter as compared with the outer diameter of the stabiliser body. During installation of a stabiliser into a hole, the tube is subject to radial compressive forces as a result of the interference fit between the tube and the surrounding rock or earthen formation and the channel or groove allows the diameter of the tube to reduce to conform the diameter of the tube with that of the hole. In using this approach, there is at least some frictional engagement between the stabiliser body and the earthen formation. In practice, stabilisers are usually supplied in a range of diameters, each diameter having a recommended load carrying capacity.

One known friction stabiliser consists of a mechanical device that includes one or more expanding mechanisms, which expand to wedge the friction stabiliser within the hole. An example is the mechanical expansion-shell type of friction stabiliser. Typically, the expanding mechanism consists of a tapered wedge and a shell that can be mechanically expanded in order to wedge the bolt within the hole drilled in the rock. These forms of expanding friction stabilisers are able to anchor the bolt only at the point of contact where the expansion mechanism contacts the rock hole surface.

Thus, except for the limited point of contact, there is no connection between the bolt and the rock for the substantial length of the hole. The cost of these expansion type anchorages increases when the mechanisms are required to be of the size to expand inside large-diameter holes. Once the expansion friction stabiliser is installed, the bolt is held only by the part that has expanded to wedge the bolt in the hole. Such point anchor friction stabilisers are ineffective particularly for high loads or for long periods of service.

In the prior art, friction stabilisers which use mechanical anchorage mechanisms, have hollow regions. When these bolts are installed, the hollow regions can be filled with grout to seal the gap between the rock and the bolt. The disadvantage is that the step of adding the grout to the hole involves a further ‘pass’, namely that a workman must re-visit the friction stabiliser to insert the grout on a “second pass”. Thus, the installation procedure requires two steps (a ‘two pass’ process). The first pass includes the steps of tightening the wedge mechanism to anchor the bolt by creating a point anchorage. The second pass includes the step of filling the gaps in the hole with a grout. Typically, in the mining industry for example, this is time consuming and expensive.

Moreover, it is appreciated that the components of the expansion anchor bolts do not always fill the interior of the rock hole, and, particularly in the case of large diameter holes, the components of the bolt may actually take up only a relatively small portion of the hole diameter. It is not always realised that the actual diameter of the hole drilled into an earthen formation usually varies along the length of the hole. FIG. 1 graphically illustrates this variance. This means that there is a relatively large volume cavity of empty space that remains in the rock hole. If these holes are then filled with grout, a large amount of grout is required to fill the empty space. The grout is usually prepared in batches and the relative strength of each batch may also vary depending on whether the workmen have followed the directions for preparing the grout correctly. For example, one batch may have more water added or may not be as well mixed as another batch, and this will effect the relative strength of the grout, leading possibly to failure of the friction stabiliser when placed under load. There may thus be a relatively poor load transfer between stabiliser and grout so the use of large amounts of grout is usually avoided. Furthermore, grout is relatively expensive, and therefore the use of excessive amounts of grout is avoided.

Other known stabilisers are shown in FIGS. 2a to 2d, details of which will be described later. The known installation procedure of installation includes determining the diameter of the tube associated with a recommended load carrying capacity of the stabiliser, drilling a hole in the earthen formation which is to be stabilised, and forcing the stabiliser into the hole using some form of impact tool.

By way of background, in the instance of underground mines, stabilisers are typically about 2.4 meters long, and have a diameter of approximately 45 mm although other diameters are also available. The hole drilled has a nominal diameter of 45 mm. It can be seen in FIG. 1 that the diameter of the hole varies from approximately 44 to 46 mm, and where the earthen formation is not stable (not shown), the diameter may vary markedly due to rocks dislodging from the side of the drilled hole. Assuming the hole is symmetrical (for the purposes of discussion), if a 45 mm stabiliser of the prior art is installed into such a hole (the nominal diameter of which is symbolised by the dotted line 2) the stabiliser will be squeezed by the earthen wall of the hole at those parts where the diameter is less than 45 mm, such as point 3. This will give relatively good frictional engagement between the earthen wall of the hole and the stabiliser, and thus enable the stabiliser to be loaded. However, the stabiliser will have less frictional contact with the earthen wall at points where the diameter is larger than 45 mm, such as point 4. At these points there is less loading ability provided by the stabiliser.

As noted above, although a stabiliser having a diameter of 45 mm has the ability to be loaded up to 4 tonnes per meter of embedment, this can be severely reduced where the bored hole does not enhance frictional engagement between the stabiliser and the earthen wall over the full length of the stabiliser as embedded.

Some examples of prior art stabilisers are illustrated, in cross section, in FIGS. 2a, 2b, 2c and 2d.

When a hollow stabiliser is inserted into earthen material, it tends to deform and match the diameter of the bored hole in the earthen material. As the stabiliser is installed, narrow portions of the hole will cause the channel or groove to close at those portions. However, once a narrow portion of the hole is passed, the channel or groove will tend to open again as the stabiliser body expands to some extent. In this respect, as the diameter of the hole varies along its length, to some extent the diameter of the stabiliser body will conform to the variations in the hole diameter.

U.S. reissue Pat. No. Re 30,256 (Scott) discloses a stabiliser similar to that illustrated in FIG. 2a. The stabiliser consists of a tube with a slot defined by edges 5 and 6 which are separate prior to installation. During the installation process, in those parts of a hole which are narrower than the nominal diameter of the stabiliser, the edges 5 and 6 are forced together (as shown by arrow 7). If portions of the hole are very narrow, the edges 5 and 6 will butt together and thus restrict any further radial compression of the stabiliser. This would make installation of the stabiliser very difficult or in some cases impossible. It has also been found in practice that the edges 5 and 6 and the inner and outer surface area are relatively exposed to water (from underground seepage) and over time the stabiliser will tend to rust and fail.

U.S. Pat. No. 4,012,913 (Scott) discloses a stabiliser similar to that illustrated in FIG. 2b. The stabiliser has offset edges 8 and 9 which are separated prior to installation. During the installation process, in the narrower parts of the hole, the edges 8 and 9 will be moved past each other as shown by arrow 10.

A further problem with stabilisers of this type is a problem referred to as ‘tangential gap’. FIG. 2c illustrates this problem. FIG. 2c is a representation of the part of FIG. 2b ‘Compressed’ marked ‘A’. As previously mentioned, as the stabiliser is installed in a hole, edges 8 and 9 are moved passed each other. However, proximate the edge 8, there is always a gap 10b (referred to as the tangential gap) which is formed as a result of the stabiliser wall 9 moving inwardly of the stabiliser wall 8. The gap is formed between the stabiliser wall 9 and the hole wall 10a. This gap reduces the overall frictional engagement of the stabiliser with the earthen formation into which the stabiliser is installed as there is no frictional engagement along the portion of the stabiliser proximate the gap 10b.

U.S. Pat. No. 5,297,900 (Witzand) discloses a stabiliser similar to that illustrated in FIG. 2d. The stabiliser has edges 12 and 13 that are separated prior to installation. The stabiliser has a ‘V’ shaped portion extending substantially along the entire length of the stabiliser. The ‘V’ shaped portion is described as providing greater frictional resistance to movement between the bolt and the mine roof as compared with slotted stabilisers (as illustrated in FIGS. 2a and 2b). During the installation process, in those parts of a hole which are narrower than the nominal diameter of the stabiliser, the edges 12 and 13 are forced together (as shown by arrow 14). As occurs in the stabiliser of FIG. 2a, if portions of the hole are very narrow, the edges 12 and 13 will butt together and thus prevent any further circumferential deformation of the stabiliser. This would make installation of the stabiliser very difficult or in some instances impossible. It has been also found in practice that many parts of the ‘V’ shape remain open and exposed to the earthen hole wall and are thus relatively exposed to water (from underground seepage) and over time the stabiliser will tend to rust and fail.

Further problems may after installation due to further radial compression. The external surface area of the stabiliser reduces thus decreasing the area over which the surrounding material has the ability to develop a frictional force to act upon the stabiliser. Radial compression of a stabiliser of this type subsequent to installation can result in premature dislodgement of the stabiliser which is unsafe.

Furthermore, the ‘V’ shaped portion of FIG. 2d, being internal to the stabiliser, is considered to inhibit the flow of grout as it is pumped internally along the length of the stabiliser. It has been found to be difficult to insert grout externally along the stabiliser proximate the ‘V’ shaped portion which is desirable in order to reduce the likelihood of further radial compression of the stabiliser subsequent to installation.

If these prior art types of stabiliser are installed in a roof section of an underground mine, and sufficient load is applied to the stabiliser, say by a portion of the roof weakening, extra load will be applied to the stabiliser, and this may act to dislodge the stabiliser. Just as the stabiliser exhibits compression and expansion as is it is inserted into the hole, equally and conversely, the stabiliser can expand and compress as it is forced out of a hole under the load of the mine roof section. In other words, the applied load may dislodge the stabiliser from the hole, with the stabiliser deforming in the direction of arrow 10 (FIG. 2b) as the stabiliser is forced out of the hole and passes the narrower parts of the hole. FIG. 3a illustrates this schematically. As the load increases on the stabiliser 31, the load carrying ability of the stabiliser is reduced 32, as the stabiliser is dislodged from its hole.

Nonetheless, is known that by providing a grout internally to the stabiliser, after the stabiliser is embedded into the hole, the support capacity of the stabiliser is increased to approximately 12-18 tonnes per meter of embedment. The grout, once set, substantially reduces any subsequent radial deformation of the stabiliser which may occur as a result of the stabiliser being subject to increased forces by movement of surrounding earthen material. Further, any load acting to dislodge or force the stabiliser out of the hole will be resisted as the load attempts to force larger diameter portions of the stabiliser body through narrower portions of the hole in which it is installed. Generally, grouting a friction stabiliser substantially increases the load carrying capacity of that stabiliser.

Of somewhat greater concern is what may happen to these types of stabilisers in the situation of a sudden seismic event. In a seismic event, a great load may be applied to the stabiliser in a relatively short period of time. As illustrated in FIG. 3b, the load may increase sharply 33 on the stabiliser. Noting that the majority of stabilisers are metal, such as steel, and that steel does not have a great deal of flexibility and/or extensibility, if this load exceeds the maximum load carrying capacity 34 the load of the stabiliser, the stabiliser may fail altogether, rather than simply dislodge. Failure of the stabiliser can cause catastrophic consequences, especially in an underground mine situation, resulting in a cave-in of the mine, for example.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

An object of the present invention is to provide an improved stabiliser and/or method of installation.

It is an object of the embodiments described herein to overcome or alleviate at least one of the above noted drawbacks of related art systems or to at least provide a useful alternative to related art systems.

In a first aspect of embodiments described herein there is provided a method of and/or system for installing a stabiliser into a hole provided in an area to be stabilised, comprising providing a filler material adapted to be associated with a stabiliser, the filler material, in association with the stabiliser, enabling frictional engagement of the stabiliser with a surrounding environment to be less than the tensile strength of the stabiliser.

In a second aspect of embodiments described herein there is provided a method of and/or system for installing a stabiliser into a hole provided in an area to be stabilised, the method comprising the steps of providing the stabiliser into the hole, and providing a filler material internal of the stabiliser, the filler material having a predetermined load carrying capacity less than the maximum load capacity of the stabiliser.

In another aspect of embodiments described herein there is provided a kit of parts comprising a stabiliser and a filler material adapted to be located internal of the stabiliser, the filler material having a predetermined load carrying capacity less than the maximum load capacity of the stabiliser.

In yet a further aspect of embodiments described herein there is provided a filler material having a predetermined load carrying capacity less than the maximum load capacity of the stabiliser.

Other aspects and preferred aspects are disclosed in the specification and/or defined in the appended claims, forming a part of the description of the invention.

In essence, the inventor has realised that the load carrying capacity of a stabiliser installed into a surrounding earthen formation is provided by the capacity of the stabiliser material itself (such as the material the stabiliser is made from, such as metal) and also the frictional engagement of the stabiliser with the surrounding earthen formation. The present invention is aimed at increasing the frictional engagement capacity, but not beyond the capacity of the stabiliser material itself. Various embodiments of the present invention stem from the realization that by using a stabiliser together with a predetermined filler material, having a predetermined load or compressibility capability, total failure of a stabiliser in-situ may be avoided or at least reduced. The filler material of the present invention can be used together with a stabiliser, which in use, is configured to engage with the surrounding environment (such as an earthen wall) in a manner which provides a load carrying capacity up to a predetermined load, the predetermined load being less than the ‘failure’ load (or tensile strength) of the stabiliser. In one embodiment of an aspect of this invention, the filler does not become “too” stiff so that the bolt can be moved in, or removed from, the hole using a forced than is lower that the tensile strength of the steel that the bolt is made from. In other words, in accordance with the present invention, the filler material of the present invention reduces its load carrying capacity prior to the load exceeding the maximum (failure) load carrying capacity of the stabiliser.

Advantages provided by the present invention comprise the following:
Enables a stabiliser to move relative to the material being stabilised rather than failing the parent material (usually steel). This enables some ‘control’ or ‘stability’ still to be exerted upon the surrounding material even in the event of relatively large loading of the stabiliser;
Allows for movement of the stabiliser, at a high load, in preference to total mechanical failure of the stabiliser;
Absorbs energy, for example during seismic activity
Provides strata stability, even during a seismic event;
Is simple to install compared to other bolts.
Is relatively inexpensive compared to other bolts
Has less chance of operator error during installation compared to other bolts
Is relatively easy to manufacture compared to other “dynamic”

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 is a graph illustrating the possible variation of hole diameter along the length of a bored hole in an earthen formation;

FIGS. 2 (a), 2 (b), 2 (c) and 2 (d) are cross sectional illustrations of examples of prior art stabilisers;

FIGS. 3a and 3b illustrate graphically the relative load/displacement characteristics of prior art stabilisers;

FIG. 4 illustrates one embodiment of the manner in which prior art stabiliser are installed;

FIG. 5 illustrates an embodiment of the present invention; and

FIG. 6 illustrates graphically the relative load carrying capability of the present invention.

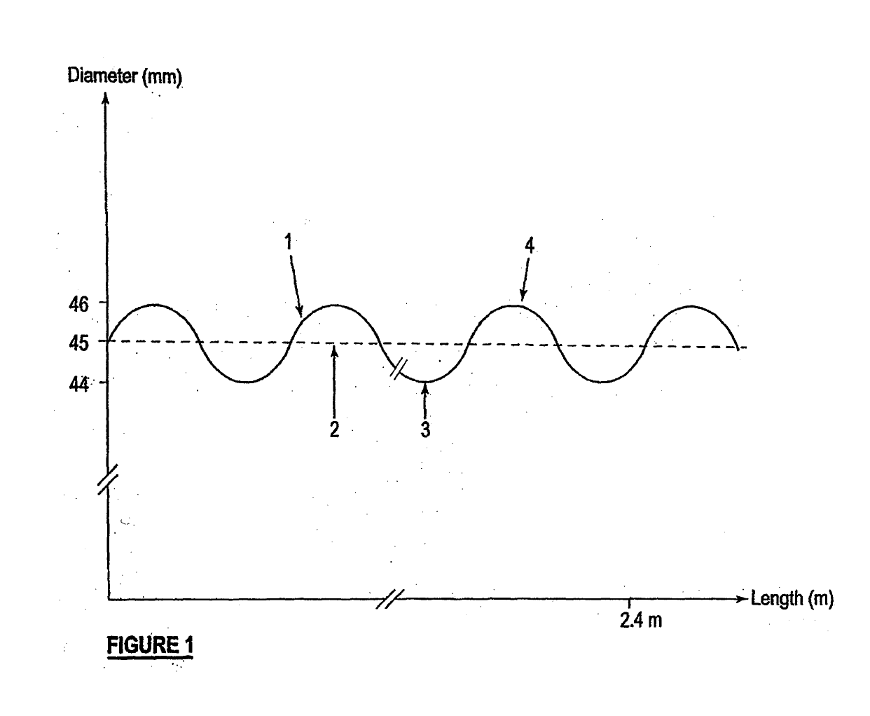

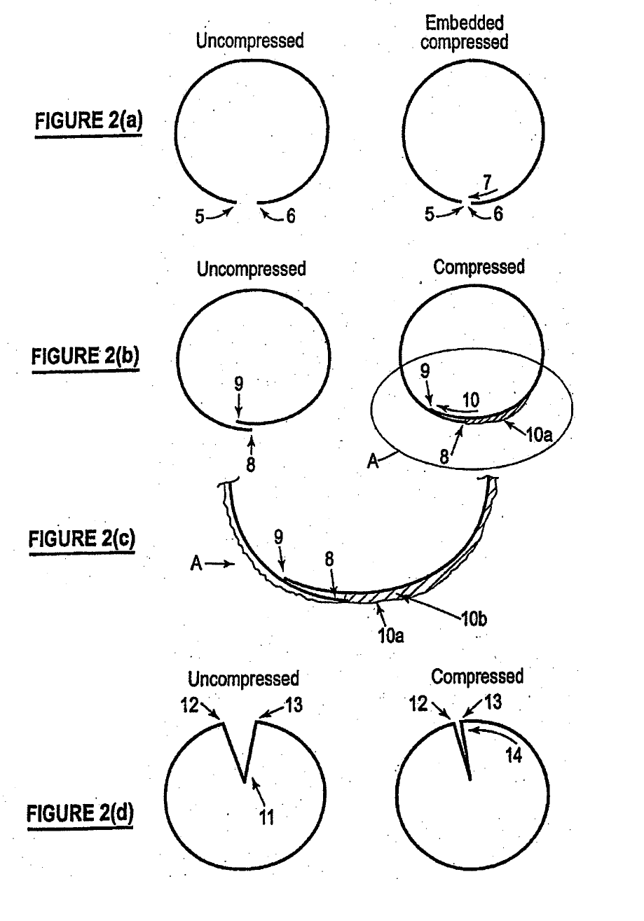

### DETAILED DESCRIPTION

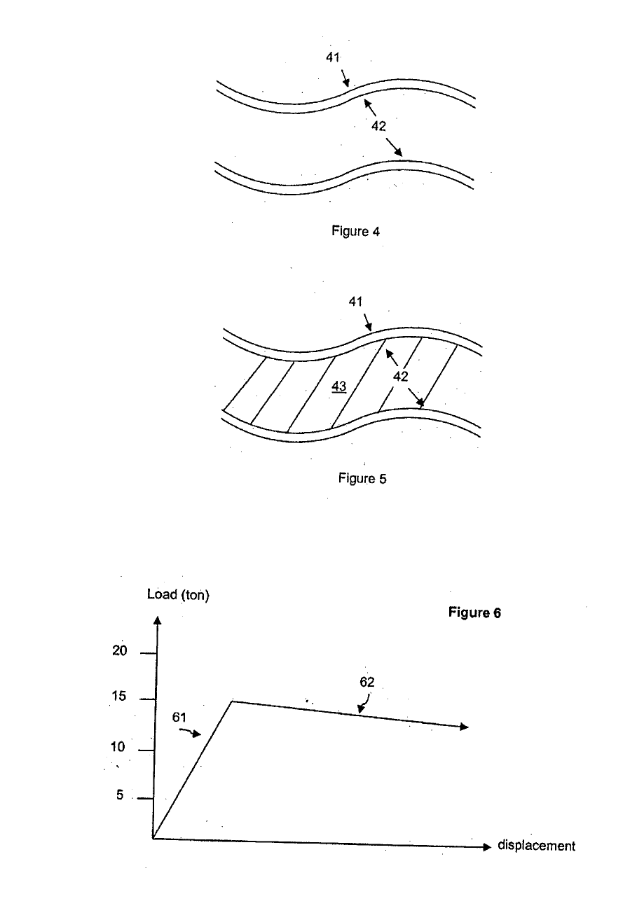

FIG. 4 illustrates a prior art embodiment. FIG. 4 illustrates a hole 41, in which a stabiliser 42 is installed. The installation of the stabiliser may be in accordance with prior art techniques. As the stabiliser is inserted into the hole, the stabiliser is deformed close to the internal shape of the hole, and the stabiliser frictionally engages the hole surface. It is to be noted that in FIG. 4, the gap between the hole 41 and the stabiliser 42 is only for the purposes of illustration.

FIG. 5 on the other hand illustrates an embodiment of the present invention. A stabiliser 42 is provided in a hole 41. The stabiliser usually deforms slightly to or close to the internal shape of the hole 41. It is to be noted that in FIG. 5, the gap between the hole 41 and the stabiliser 42 is only for the purposes of illustration. The stabiliser may be any type of stabiliser. The stabiliser may be of the form disclosed in co-pending patent application WO2003014517. In accordance with the present invention however, the stabiliser has a filler material 43 provided internal of the stabiliser. Unlike grout (of the prior art) which is relatively rigid and inflexible, the filler material of the present invention does have some (limited) compressibility and/or flexibility.

In operation, should the stabiliser be put under a relatively large load, prior art stabilisers will fail should the load exceed the load capacity of the stabiliser. In accordance with the present invention, however, under a relatively large load, the filler material will compress a relatively small amount (depending on the selected characteristics of the filler compound), which will allow the stabiliser to move or deform a little rather than fail. Although the filler will enable the stabiliser to ‘give’ a little according to the present invention, the varying diameter of the hole 41 will usually be such that the stabiliser will not deform by an amount that will allow the stabiliser to completely free itself from the hole. In other words, the stabiliser will most likely re-engage with another portion of the hole as the filler will only compress or deform a limited amount.

In selecting the characteristics of the filler compound, it should have a load capacity that can be selected depending on the required deformation characteristics of the installed stabiliser. In other words, the force required to compress or deform the filler should be less than the maximum ‘failure’ load of the stabiliser. The components of the compound may be typically something strong like a grout and a deformable additive such as an expanded material, non-expanded material and/or particulate material. Typically the compound will be an expanded polymer, non-expanded polymer and/or particulate polymer derived from polystyrene, polyurethane, polypropylene, polyethylene or polyolefins.

Expanded materials have a weight per unit volume which is essentially lower than that of homogeneous expanded material. Expanded polymers include many different kinds of materials, such as foamed polymers, foamed rubbers and other expanded polymers. For example, the expanded material used for the present invention may be an expanded polymer such as expanded polystyrene, polyurethane or polypropylene. The properties of the expanded polymer will depend on compositional parameters including the choice of polymer, the crosslinker and additives. The composition can thus be varied to obtain the desired characteristics of features such as load carrying capacity, compressive strength, shear modulus and frictional coefficient.

The particulate material may for example be polymer beads, such as expanded polymer beads, or recycled plastics granules so that the compressive strength can be tailored to suit the deformation characteristics of the installed device. The properties of the particular material will depend on both the compositional parameters of the material, and the physical characteristics of the particles, such as their friability and packing profile.

There may be other chemical(s) or substances mixed together to form the filler compound so as to achieve the selected compressive strength.

Furthermore, as an alternative, it is possible to use a plug (not shown) comprising at least one polymeric material which is inserted internal of a stabiliser, such as disclosed in WO 200314517. When inserted into the hole, the plug initially deforms to the shape of the internal surface of the stabiliser, and after installation, the plug becomes more resilient to deformation, although it will still deform under relatively high loads in accordance with the present invention.

The filler compound has the following characteristics:
To be ductile during installation
To covert to be rigid after installation expect for minor deformation.
To be relatively inexpensive
To be easier to facilitate the transition from ductility to rigidity
To allow to be packaged fro easy installation into the bolt either at a manufacturing facility or on site.

In installing a stabiliser in accordance with the present invention, the following steps may be followed:
The stabiliser may be like a tube with a slot such as that disclosed in WO2003014517. A filler material may be placed inside the tube.
The slot is covered so that little, if any, of the filler can escape.
The bolt is pushed into a hole of a slightly smaller diameter than the bolt thus deforming the bolt and the filler material.
The filler material sets i.e. is ductile during insertion but then becomes “stiff”
In this invention the filler does not become “too” stiff so that the bolt can be removed from the hole using a forced than is lower that the tensile strength of the steel that the bolt is made from
During rock movement (or seismic activity) the seismic forces move the rock and thus the bolt but because the filler is ductile to some degree that bolt does not break, rather it moves in or perhaps out of the hole.

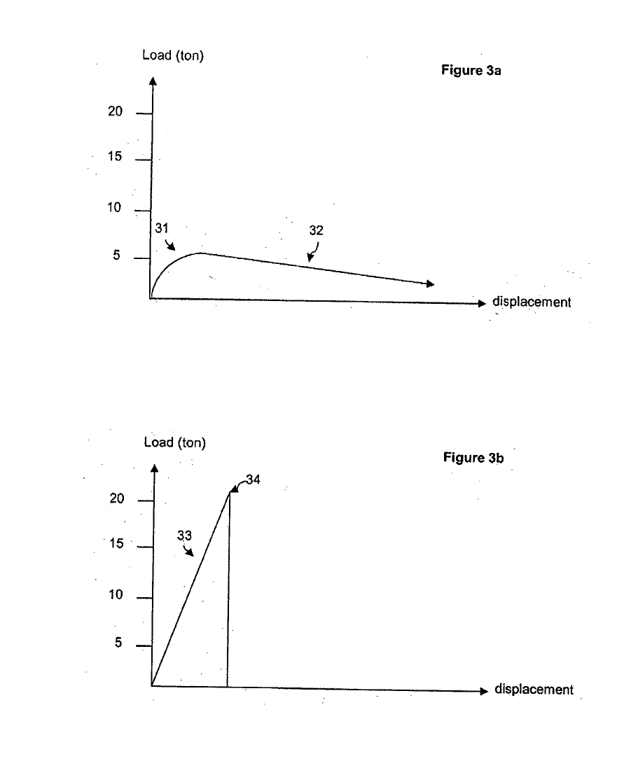

FIG. 6 illustrates graphically the relative load carrying capability of the present invention. Under an increasing load 61, the stabiliser according to the present invention will carry that load, up to a predetermined load 62. The predetermined load is less than a load at which the stabiliser will catastrophically fails (see FIG. 3b).

In a further embodiment, the filler material of the present invention may be provided only over a portion, such as at one end of the stabiliser, and (not the entire length) of the stabiliser. This ‘partial engagement’ may also be selected in a manner which provides a predetermined load capacity of an installed stabiliser in accordance with the present invention, in which the selected load capacity of the installed stabiliser is less than the maximum ‘failure’ load of the stabiliser, itself.

In an alternative embodiment, the filler is compressed so much that it becomes effective rigid conveying the rigidity to the bolt.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A method of installing a stabiliser into a hole provided in an area to be stabilised, the method comprising the step of:
providing a filler material adapted to be associated with a stabiliser, the filler material, in association with the stabiliser, enabling frictional engagement of the stabiliser with a surrounding environment to be less than the tensile strength of the stabiliser.

2. A method as claimed in claim 1, wherein the filler material is a grout having a deformable additive.

3. A method as claimed in claim 2, wherein the deformable additive is chosen from the group comprising expanded material, non-expanded material, particulate material and combinations thereof.

4. A method as claimed in claim 3 wherein the expanded material, non-expanded material and particulate material are derived from polystyrenes, polyurethanes or polyolefins.

5. A method as claimed in claim 3 wherein the deformably additive is an expanded polymer chosen from the group comprising polyurethane foam, polyethylene foam and polypropylene foam.

6. A method as claimed in claim 1, wherein the stabiliser is a stabiliser as disclosed in PCT publication number WO200314517.

7. A method of installing a stabiliser into a hole provided in an area to be stabilised, the method comprising the steps of:
providing the stabiliser into the hole, and
providing a filler material internal of the stabiliser,
the filler material in combination with the stabiliser having a predetermined load carrying capacity less than the maximum load capacity of the stabiliser.

8. A method as claimed in claim 7, wherein the filler material is a grout having a deformable additive.

9. A method as claimed in claim 7, wherein the deformable additive is chosen from the group comprising expanded material, non-expanded material, particulate material and combinations thereof.

10. A method as claimed in claim 9 wherein the expanded material, non-expanded material and particulate material are derived from polystyrenes, polyurethanes or polyolefins.

11. A method as claimed in claim 9 wherein the deformable additive is an expanded polymer chosen from the group comprising polyurethane foam, polyethylene foam, polypropylene foam and combinations thereof.

12. A method as claimed in claim 7, wherein the filler material is a polymer plug.

13. A method as claimed in claim 12, wherein the polymer comprising the polymer plug is derived from a polystyrene, a polyurethane, or a polyolefin.

14. A method as claimed in claim 7, wherein the stabiliser is a stabiliser as disclosed in PCT publication number WO200314517.

15. A kit of parts comprising:
a stabiliser and
a filler material adapted to be located internal of the stabiliser, the filler material having a predetermined load carrying capacity less than the maximum load capacity of the stabiliser.

16. A kit of parts as claimed in claim 15, wherein the filler material is a grout having a deformable additive, such as an expanded polymer, polyurethane foam, or a polyurethane plug.

17. (canceled)

18. A kit of parts as claimed in claim 15, wherein the stabiliser is a stabiliser as disclosed in PCT publication number WO200314517.

19. A filler material adapted for use in accordance with a method of installing a stabiliser into a hole provided in an area to be stabilised, the method comprising the step of: providing a filler material adapted to be associated with a stabiliser, the filler material, in association with the stabiliser, enabling frictional engagement of the stabiliser with a surrounding environment to be less than the tensile strength of the stabiliser, wherein the filler material has any combination of the following characteristics:
ductile during installation,
covert to be relatively rigid after installation,
allow for relatively minor deformation,
relatively inexpensive,
relatively easier to facilitate the transition from ductility to rigidity,
allow to be packaged for easy installation into the stabiliser either at a manufacturing facility or on site, and
enabling frictional engagement of the stabiliser with a surrounding environment to be less than the tensile strength of the stabiliser.

20. A filler material adapted for use in accordance with a stabiliser, the filler material having a predetermined load carrying capacity less than the maximum load capacity of the stabiliser, the filler material having any combination of the following characteristics:
ductile during installation,
covert to be relatively rigid after installation,
allow for relatively minor deformation,
relatively inexpensive,
relatively easier to facilitate the transition from ductility to rigidity,
allow to be packaged for easy installation into the stabiliser either at a manufacturing facility or on site, and
enabling frictional engagement of the stabiliser with a surrounding environment to be less than the tensile strength of the stabiliser.

21-22. (canceled)

23. A filler material adapted for use in accordance with a method of installing a stabiliser into a hole provided in an area to be stabilised, the method comprising the steps of: providing the stabiliser into the hole, and providing a filler material internal of the stabiliser, the filler material in combination with the stabiliser having a predetermined load carrying capacity less than the maximum load capacity of the stabiliser, wherein the filler material has any combination of the following characteristics:
ductile during installation,
covert to be relatively rigid after installation,
allow for relatively minor deformation,
relatively inexpensive,
relatively easier to facilitate the transition from ductility to rigidity,
allow to be packaged for easy installation into the stabiliser either at a manufacturing facility or on site, and
enabling frictional engagement of the stabiliser with a surrounding environment to be less than the tensile strength of the stabiliser.
